(19) United States
(12) Patent Application Publication
(10) Pub. No.: US 2025/0390785 A1
(43) Pub. Date: Dec. 25, 2025

(54) USING AND TRAINING SUBSETS OF LAYERS OF A MACHINE LEARNING MODEL TO NOT OUTPUT DATA TO UNLEARN

(71) Applicant: INTERNATIONAL BUSINESS MACHINES CORPORATION, ARMONK, NY (US)

(72) Inventors: Ling Cai, Santa Clara, CA (US); Yi Zhou, San Jose, CA (US); Nathalie Baracaldo Angel, San Jose, CA (US); Swanand Ravindra Kadhe, San Jose, CA (US)

(21) Appl. No.: 18/750,300

(22) Filed: Jun. 21, 2024

(51) Int. Cl. G06N 20/00

(52) U.S. Cl. CPC G06N 20/00

(57) ABSTRACT

Provided are a computer program product, system, and method for a machine learning model trained to not output data to unlearn. A query is processed at a first set of layers of the L layers of the machine learning model to determine interim output. The interim output is classified as data to unlearn or data to keep. The interim output is processed at a second set of layers of the L layers of the machine learning model to produce a first output in response to classifying the interim output as data to keep. The interim output is inputted to an edited machine learning model formed from the second set of layers to output second output in response to classifying the interim output as the data to unlearn from the machine learning model. The first output or the second output is returned as a response to the query.

### BACKGROUND OF THE INVENTION

### 1. Field of the Invention

The present invention relates to a computer program product, system, and method for a machine learning model trained to not output data to unlearn.

### 2. Description of the Related Art

Modern data regulatory frameworks, such as the European General Data Protection Regulation (GDPR) and California Consumer Privacy Act (CCPA), as well as additional data protection regulations in other countries, including intellectual property protections, grant data subjects the right to withdraw their consent to the use and processing of their personal data, as well as request the deletion of their data from organizations' data stores. These regulations are known as “the right to be forgotten”. Membership and attribute inference attacks have shown that personal information is present in and can indeed be extracted from machine learning models trained on data sets including user personal information. This has led some experts to the conclusion that machine learning models themselves can be considered personal information, and therefore subject to data privacy and data opt-out laws. Upon a data removal request, current systems process the machine learning model with an unlearning algorithm to forget the data incorporated inside the model. Unlearning algorithms operate by obtaining a model that is as similar as possible to another model trained without using the forget data or data to unlearn.

### SUMMARY

Provided are a computer program product, system, and method for a machine learning model trained to not output data to unlearn. A query is processed at a first set of layers of the L layers of the machine learning model to determine interim output. The interim output is classified as data to unlearn or data to keep for the machine learning model. The interim output is processed at a second set of layers of the L layers of the machine learning model to produce a first output in response to classifying the interim output as data to keep for the machine learning model. The interim output is inputted to an edited machine learning model formed from the second set of layers to output second output in response to classifying the interim output as the data to unlearn from the machine learning model. One of the first output or the second output is returned as a response to the query.

### BRIEF DESCRIPTION OF THE DRAWINGS

FIG. 1 illustrates an embodiment of a computer system and inference hardware to process queries and generate a response to the queries from a machine learning model.

FIG. 2 illustrates an embodiment of a training system to train a subset of layers of a machine learning model to adjust the weights of the subset of layers to not output data to unlearn or forget.

FIG. 3 illustrates an embodiment of operations to process a query using subsets of layers of the machine learning model to output a response to the query.

FIG. 4 illustrates an embodiment of operations to train a gate classifier used in processing the query.

FIG. 5 illustrates an embodiment of operations to train an edited machine learning model of the machine learning model to not output data to unlearn.

FIG. 6 illustrates a computing environment in which the components of FIGS. 1 and 2 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer-implemented method for processing unlearning data from a machine learning model having L layers. The method comprises processing a query at a first set of layers of the L layers of the machine learning model to determine interim output. The method further comprises determining whether the interim output is classified as data to unlearn from the machine learning model to data to keep. The method further comprises processing the interim output at a second set of layers of the L layers of the machine learning model to produce a first output in response to determining that the interim output is classified as data to keep for the machine learning model. The method further comprises inputting the interim output to an edited machine learning model formed from the second set of layers to output second output in response to determining that the interim output is classified as the data to unlearn from the machine learning model. The method further comprises returning one of the first output or the second output as a response to the query. Thus, embodiments advantageously allow the second set of layers of the machine learning model, which have not has not been trained to unlearn data, to process interim output from a first set of layers that is classified as data to keep. However, the interim output classified as data to unlearn is inputted to an edited machine learning model, formed from the second set of layers trained to unlearn the data, to output data that is not data to unlearn. This architecture optimizes training to unlearn data because only a subset of layers of the machine learning model is trained to unlearn data, not the entire model.

Example 2: The limitations of any of Examples 1 and 3-9, where the method further comprises a gate classifier that classifies the interim output as the data to unlearn or data to keep for the machine learning model. The method further comprises selecting a set of samples comprising unlearn samples comprising the data to unlearn and keep samples comprising samples to keep. The method further comprises receiving labels comprising an unlearn value for the unlearn samples and a keep value for the keep samples. The method further comprises training the gate classifier to output the unlearn value for input comprising features derived from a sample labeled with the unlearn value and output the keep value for input comprising features derived from a sample labeled with the keep value. Thus, embodiments advantageously allow the use of a gate classifier trained to classify interim output from the first set of layers as data to unlearn or keep so that the proper subset of layers can be used to process the interim output to optimize output and training.

Example 3: The limitations of any of Examples 1, 2 and 4-9, where the training the gate classifier comprises tokenizing samples labeled with the unlearn value or the keep value, inputting the tokens for the samples into the first set of layers to obtain activations for the tokens, and averaging the activations for the tokens to produce features of interim outputs for the samples to input to the gate classifier to train the gate classifier to output the keep value or the unlearn value for the activations. Thus, embodiments advantageously form the features used to train the gate classifier to output the correct classification by averaging activations for the tokens from the samples of data to keep or data to learn.

Example 4: The limitations of any of Examples 1-3 and 5-9, where the method further comprises selecting the keep samples that are semantically similar to the unlearn samples. Thus, embodiments advantageously allow training of the gate classifier to distinguish as data to keep samples that are semantically similar to the data to unlearn, but have been labeled as data to keep so the gate classifier does not classify data that should be kept as data to unlearn when the data to keep is semantically similar to the data to unlearn.

Example 5: The limitations of any of Examples 1-4 and 6-9, where the method further comprises that a gate classifier determines whether the interim output is similar to the data to unlearn from the machine learning model. The method further comprises augmenting samples in a set of samples to produce augmented samples comprising augmented unlearn samples and augmented keep samples. The augmented samples are formed by lexical substitution to augment the samples with synonyms and other semantically similar terms. The method further comprises labeling the augmented unlearn samples with an unlearn value indicating data to unlearn and labeling the augmented keep samples with a keep value indicating data not to unlearn. The method further comprise training the gate classifier to output the unlearn value for the samples labeled with the unlearn value and output the keep value for the samples labeled with the keep value. Thus, embodiments advantageously allow training of the gate classifier with an augmented sample set such that the augmented samples are labeled as data to keep or data to unlearn to increase the size of the training set and optimize the classification, so that data that is semantically similar to the data to unlearn and data to keep is correctly classified.

Example 6: The limitations of any of Examples 1-5 and 7-9, where the method further comprises training the edited machine learning model to receive, as input, interim outputs from the first set of layers and not output the data to unlearn. Thus, embodiments advantageously allow the edited machine learning model, which receives the interim output classified as data to unlearn, to not output the data to unlearn so that the machine learning model as a whole is trained to not output data that needs to be unlearned.

Example 7: The limitations of any of Examples 1-6 and 8-9, where the method further comprises training the edited machine learning model to not output the data to unlearn by selecting a set of samples comprising unlearn samples comprising the data to unlearn and keep samples comprising samples to keep. The method further comprises using contrastive learning to train the second set of layers with input comprising interim outputs from the first set of layers to distinguish between interim outputs from the samples to keep and the samples to unlearn. Thus, embodiments advantageously perform contrastive learning to train edited machine learning model to discriminate between unlearn and keep data, resulting in fine-tuning of the edited machine learning model to further optimize not outputting data to unlearn.

Example 8: The limitations of any of Examples 1-7 and 9, where the method further comprises that the edited machine learning model comprises the second set of layers and a low-rank adaptation module. The method further comprises that the training the edited machine learning model training weights of the low-rank adaptation module, holding weights of the second set of layers constant, to not output interim outputs received as input comprising data to unlearn. Thus, embodiments advantageously optimize training by only having to train low-rank matrices of the second set of layers instead of having to train all L layers of the full model, which is less time consuming and more computationally efficient.

Example 9: The limitations of any of Examples 1-8, where the method further comprises training the edited machine learning model by classifying, by a gate classifier, the interim outputs as data to keep or data to unlearn. The weights of the low-rank adaptation module are only trained with the interim outputs classified as data to unlearn. Thus, embodiments advantageously provide a gate classifier to distinguish interim output as data to keep or unlearn, so that the low-rank adaptation module, which is more efficient to train than the entire model, is trained with the data to unlearn so as not to output data to unlearn.

Example 10 is an apparatus comprising means to perform a method of any of the Examples 1-9.

Example 11 is a machine-readable storage including machine-readable instructions, when executed, to implement a method or realize an apparatus of any of the Examples 1-9.

Example 12: A system comprising one or more processor and one or more computer-readable storage media collectively storing program instructions which, when executed by the processor, are configured to cause the processor to perform a method according to any of Examples 1-9.

Example 13: A computer program product comprising one or more computer readable storage media, and program instructions collectively stored on the one or more computer readable storage media, the program instructions comprising instructions configured to cause one or more processors to perform a method according to any one of Examples 1-11.

Example 14: An inference engine comprising hardware components, including integrated circuits, implementing components trained to unlearn data from the machine learning model.

Described embodiments provide improved computer technology for an architecture of a machine learning model that is structured to optimize the training operations to remove samples of data to unlearn. Described embodiments optimize the training by first dividing the machine learning model M_{1 . . . L} of L layers into a first set of layers M_{1 . . . k} and a second set of layers M_{k+1 . . . L}, and then combining the second set of layers with a low-rank adaptation module, having matrices of lower rank than the second set of layers, and training the weights of the low-rank adaptation module when combined with the second set of layers to not output the data to unlearn. Described embodiments substantially reduce the computations needed to train the machine learning model to unlearn data by restricting training to a low-rank adaptation module that has lower rank than the second set of layers. This provides a substantial reduction in the number of parameters or number weights that need to be trained to not output the data to unlearn than having to retrain the all the weights of the machine learning model to unlearn the data.

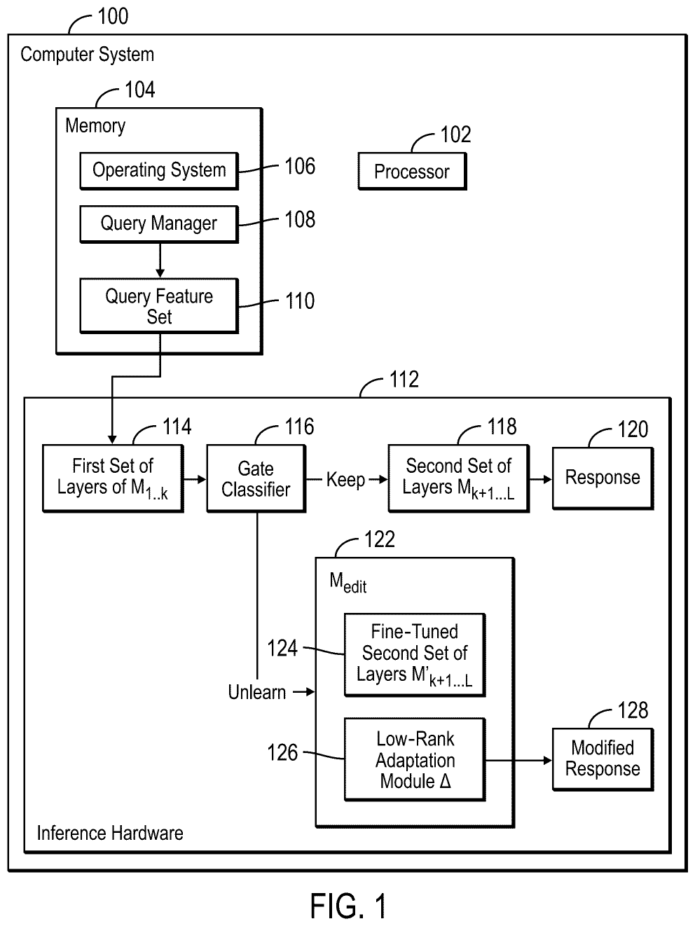

FIG. 1 illustrates an embodiment of a computer system 100 including a processor 102 and memory 104 having an operating system 106 and a query manager 108 to receive a query for a response, such as a natural language query for a response from a large language model (LLM) having L layers, M_{1 . . . L}. The query manager 108 may extract a query feature set 110 for the query and forward to inference hardware 112 having subsets of layers of the machine learning model M_{1 . . . L} process the input feature set 110 to generate the query response. In described embodiments, the inference hardware 112 includes a first set of layers (M_{1 . . . k}) 114 of the machine learning model M_{1 . . . L} to output interim output from a subset of all the layers of the model; a gate classifier 116, which may comprise a machine learning model, to classify the interim output from the first set of layers 114 as data to unlearn or data to keep; a second set of layers M_{k+1 . . . L} 118 of the original machine learning model M_{1 . . . L} to process the interim output if the gate 116 classifies the interim output as data to keep to produce a response 120 to return to the query manager 108; and an edited machine learning module (M_{edit}) 122, comprising a fine-tuned second set of layers M′_{k+1 . . . L} 124 and a low-rank adaptation module (Δ) 126 comprising a decomposed representation of a weight update matrix for the fine-tuned second set of layers M′_{k+1 . . . L} 124.

Weights of the adaptation module Δ 126 are trained to modify the weights of the second set of layers to output a modified response 128 that would not comprise data to unlearn. For instance, M_{edit} 122 may comprise M′_{k+1 . . . L}+Δ, a sum of the fine-tuned second set of layers 124 matrix and the low-rank adaptation module 126 matrix. The low-rank adaptation module 126 may comprise one or more matrices having a lower rank of columns and/or rows than the rank of the fine-tuned second set of layers 124. Training computational processing is optimized by only training the lower rank adaptation module 126 because the low-rank adaptation module 126 has fewer layers and weights to train than the second set of layers 124.

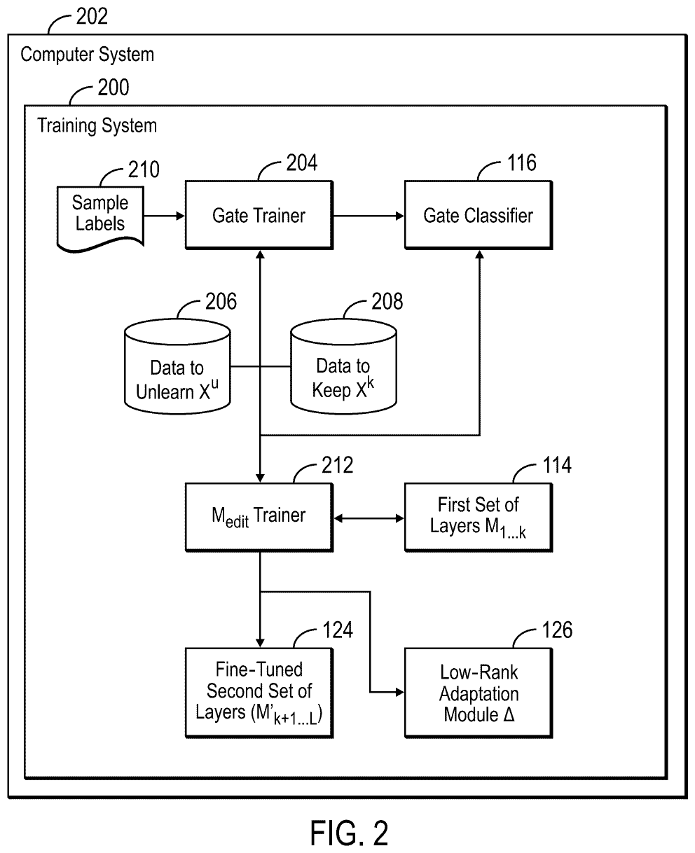

FIG. 2 illustrates an embodiment of a training system 200 used to train the machine learning models 116, 124, and 126 implemented in the inference hardware 112. The training system 200 may be implemented in a computer system 202 that is separate from the computer system 100 in which the inference hardware 112 is deployed or be implemented on the same computer system 100. For instance, the computer system 200 may comprise a developer system to train the inference hardware 112 machine learning models 114, 116, 118, 122, 124, 126 before being deployed to customers. Alternatively, the training system 200 may be implemented at the customer system 100 to perform local training of the inference hardware 112.

The training system includes a gate trainer 204 that receives samples of data to unlearn X^{u} 206 and data to keep X^{k} 208 as well as sample labels 210 that define whether a sample 206, 208 comprises data to unlearn or data to keep. The data to unlearn 206 comprises data that the implementation of the machine learning model M_{1 . . . L} in the machine learning components 114, 118, 122 needs to be trained to forget, such as data subject to copyright protection, personal identifiable information, and other data subject to laws and regulatory restrictions. The gate trainer 204 trains the gate classifier 116 on the inference hardware 112 to classify samples of data as data to unlearn or data to keep, using the labels 210.

The training system 200 further includes an M_{edit} trainer 212 that obtains from the first set of layers 114 interim outputs from the samples to train the second set of layers 118, while holding the first set of layers 114 frozen, to discriminate between data to unlearn and data to keep, such as by using a contrasting learning technique. The trained second set of layers 118 comprise the fine-tined second set of layers 124, trained to more accurately discriminate between data to keep and data to learn. The M_{edit} trainer 212 trains a low-rank adaptation module Δ 126, comprising layers of low rank matrices having lower rank than the matrices of the second set of layers 124, of the changed weights to update the weights of the fine-tuned second set of layers 124 to not output data to unlearn. In one embodiment, the adaptation module 126 may be trained using a low-rank adaptation (LoRA) technique to provide adjusted weights for the second set of layers 124, such that M_{edit}=M′_{k+1 . . . L}+Δ, where Δ comprises the low-rank adaptation module 126. The low-rank adaptation module 126 may be trained, while holding the first set of layers 114 and the fine-tuned second set of layers 124 frozen, to unlearn or not output the data to unlearn 206.

In alternative embodiments, M_{edit} 122 may be produced by training techniques other than low-rank adaptation techniques to adjust the second set of layers 118 to not output the data to unlearn.

The training system 200 seeks to accomplish the simultaneous goals when training M_{edit} 122 to forget or unlearn the data to unlearn 206 but keep the data to keep 208.

In the training system 200, the gate trainer 204 and M_{edit} trainer 212 may comprise computer programs executing in memory, and the machine learning models 116, 114, 124, and 126 may be implemented and trained in the inference hardware 114 to adjust the weights and gradients of the models.

The arrows shown in FIGS. 1 and 2 between the components and objects represent a data flow between the components.

In certain embodiments, many of the described components, such as the machine learning models 114, 116, 118, 122, 124, 126 may use gradient-based models such as neural network and deep learning algorithms and architectures, such as deep neural networks (DNN), recurrent neural networks (RNN), Feedforward neural networks, Convolutional Neural Networks (CNN), Transformer networks, etc. For artificial neural network program implementations, the neural network may be trained using backward propagation to adjust weights and biases at nodes in a hidden layer. Backward propagation used to train a neural network machine learning module to compute the gradient of the loss function with respect to the weights of the network, iterating backward from the last layer, using the chain rule.

Backward propagation may be used with an algorithm for supervised learning of artificial neural networks using gradient descent. Given an artificial neural network and an error function, the method may use gradient descent to find the weights or coefficients, for the nodes in a neural network or function that minimizes a cost function measuring the difference or error between actual and predicted values for different weights. The parameters are continually adjusted during gradient descent to minimize the error.

Generally, program modules, such as the program components 106, 108, 114, 116, 118, 122, 124, 126, 204, 212 may comprise routines, programs, objects, components, logic, data structures, and so on that perform particular tasks or implement particular abstract data types. The program components and hardware devices of the computer systems 100, 202 in FIGS. 1 and 2 may be implemented in one or more computer systems, where if they are implemented in multiple computer systems, then the computer systems may communicate over a network.

The inference hardware 112 may comprise one or more hardware devices, such as Graphic Processing Units (GPUs), Application Specific Integrated Circuit (ASIC), Field Programmable Gate Array (FPGA), etc. In alternative embodiments, the machine learning models 114, 116, 118, 122 may be implemented in program components accessed by a processor from memory to execute.

The program components in FIGS. 1 and 2, including components 106, 108, 204, 212, may be accessed by a processor from memory to execute. Alternatively, these program components may be implemented in the inference hardware 112 or other hardware devices.

The functions described as performed by the program components of FIGS. 1 and 2, including components 106, 108, 114, 116, 118, 122, 124, 126, 204, 212, may be implemented as program code in fewer program modules than shown or implemented as program code throughout a greater number of program modules than shown.

The computer systems 100, 202 may comprise a personal computing device, such as a laptop, desktop computer, tablet, smartphone, wearable computer, server class computing devices, or other suitable computing devices.

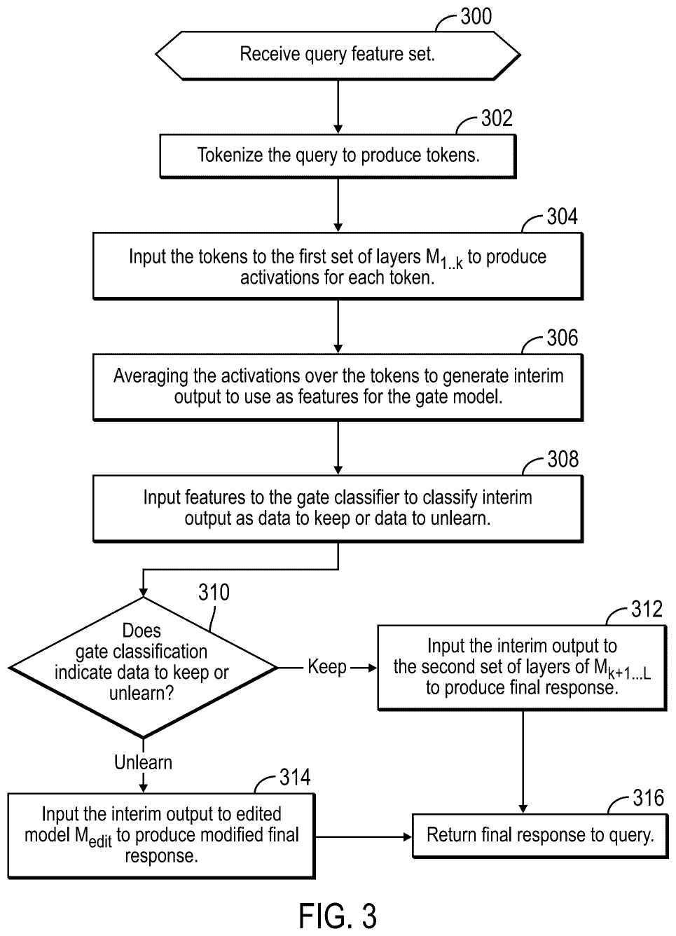

FIG. 3 illustrates an embodiment of the operations performed in the inference hardware 112 to process a query request. Upon receiving (at block 300) a query feature set 110 for a query from a query manager 108 in the computer system 100, the inference hardware 112 tokenizes (at block 302) the query to produce tokens. The tokens are inputted (at block 304) to the first set of layers M_{1 . . . k} 114. The output activations from M_{1 . . . k} 114 may be averaged (at block 306) over the tokens, using average pooling, to generate interim output to use as features for the gate classifier 116. The gate classifier 116 classifies the interim output as data to keep or data to unlearn. If (at block 310) the classification is data to keep, then the interim output is inputted (at block 312) to the second set of layers M_{k+1 . . . L} 118 to output (at block 314) a response 120 to the query to return to the query manager 108 to return to the query initiator. If (at block 310) the classification is data to unlearn, then the interim output is inputted (at block 314) to the edited model M_{edit} 124, which may comprise comprising M_{k+1 . . . L}+Δ. The final response from the processing at block 312 or 314 is returned (at block 316) to the query.

Described embodiments provide computer architecture implemented in inference hardware to allow for removing data to forget or unlearn from a machine learning model, such as an LLM, without having to retrain the entire model. Described embodiments optimize the unlearn processing by inserting a gate between the layers of the model to classify the interim output of the first set of layers of the model as data to keep or unlearn, and then using the already existing set of layers to continue processing if the interim output is data to keep. Further, if the interim output is likely data to unlearn, then a low-rank adaptation module is used to adjust the output of the second set of layers. This architecture allows unlearning data from a machine learning model without having to retrain the entire model with a full data set not including the data to learn.

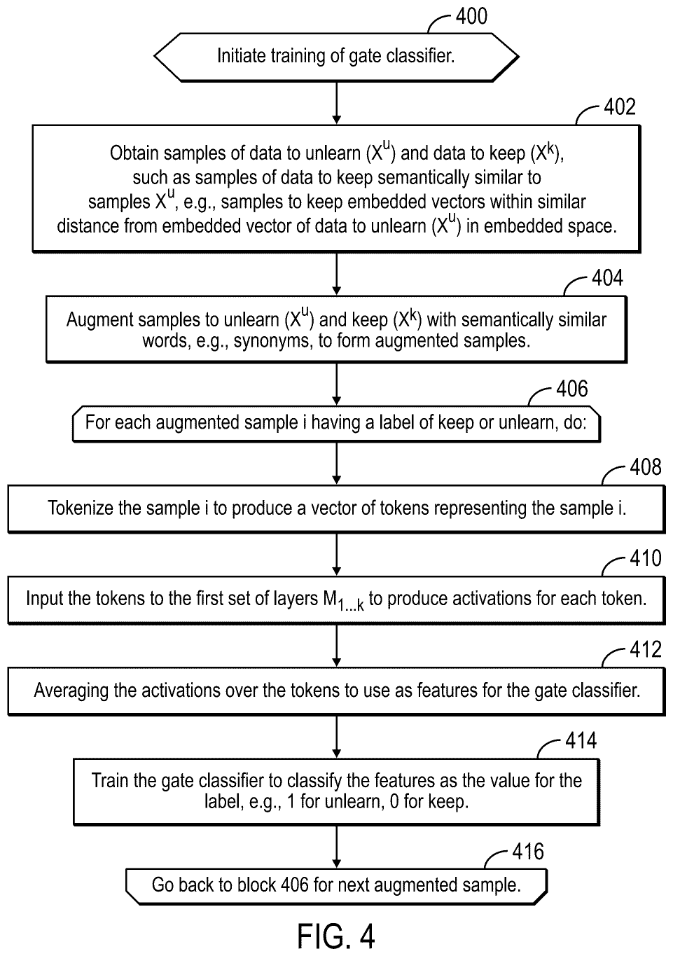

FIG. 4 illustrates an embodiment of operations performed by the gate trainer 204 to train the gate 116 to classify interim output from the first set of layers M_{1 . . . k} 114 as data to unlearn or data to keep. Upon initiating (at block 400) training of the gate classifier 116, the gate trainer 204 obtains (at block 402) samples of data to unlearn (X_{U}) 206 and data to keep (Xₖ) 208. In one embodiment, the samples of data to keep may be selected that are semantically similar to samples to unlearn X_{U}. For instance, semantically similar may be determined when the selected samples to keep 208 form embedded vectors in an embedded space that are within a predefined distance in the embedded space to embedded vectors of the samples to unlearn 206. This allows training to output responses that may be similar to the data to unlearn, but sufficiently different to avoid violating any rules restricting usage of the data to unlearn. In an alternative embodiment, the samples to keep may be randomly selected.

The selected samples to unlearn (X^{u}) and keep (X^{k}) may be augmented (at block 404) with semantically similar words, e.g., synonyms, to form augmented samples. For each augmented sample of data to keep or unlearn, a loop of operations is performed at blocks 406 through 416. At block 408 the sample i is tokenized (at block 408) to produce a vector of tokens representing the sample. The tokens are inputted (at block 410) to the first set of layers M_{1 . . . k} 114 to produce activations for the tokens. The activations are averaged (at block 412) over the tokens to produce features for input to the gate classifier 116. The gate classifier 116 is trained (at block 414) to classify the features as the value for the label, e.g., 1 for unlearn or zero for keep. In embodiments where the gate classifier 116 comprises a neural network, backpropagation may be used to train the weights and gradients of the gate classifier 116. In alternative embodiments, such as where the gate classifier 116 comprises an alternative machine learning model, such as a decision tree, distributed gradient-boosted decision tree (GBDT), or extreme gradient boosting decision tree (XGBoost), hierarchical rules, etc., different training techniques may be used to train the gate classifier 116.

In the embodiment of FIG. 4, the training operations at blocks 408 through 414 are described as performed sequentially for each sample. In an alternative embodiment, the training operations using the samples may be performed by batching the samples into one or more batches, where the feature vectors of the samples in the batch form concurrent vectors or a matrix of sample feature vectors to perform batch gradient descent to train.

With the embodiment of FIG. 4, a gate classifier 116 is trained to distinguish between data to unlearn and data to keep to determine whether the interim output from the first set of layers M_{1 . . . k} 114 is to be processed by the original second set of layers M_{k+1 . . . L} 118 or an M_{edit} model 122 trained to not output data to unlearn from input comprising the interim output result from the first set of layers M_{1 . . . k} 114.

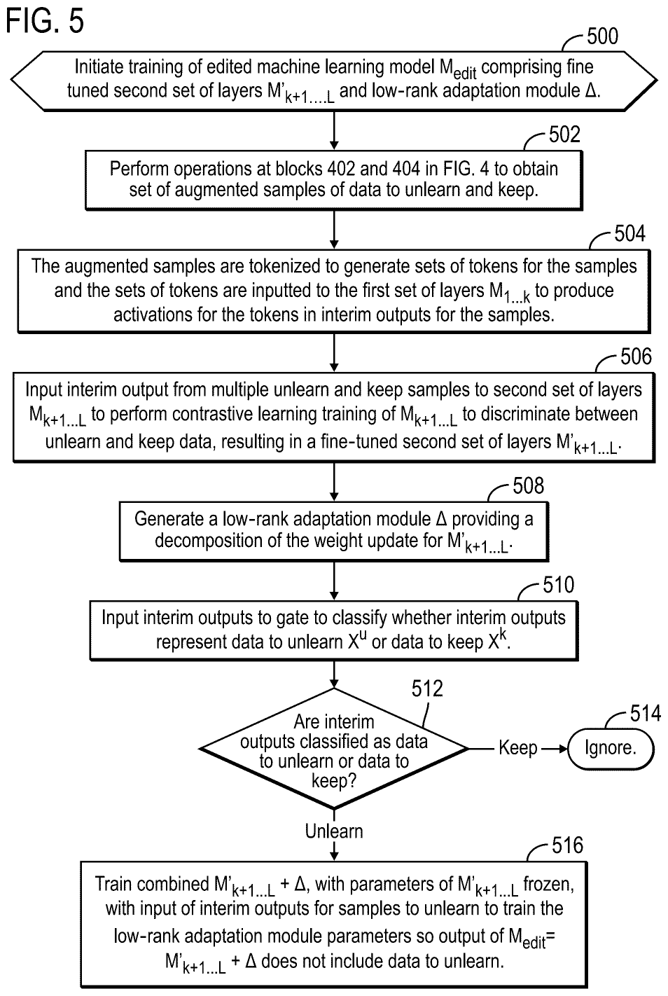

FIG. 5 illustrates an embodiment of operations performed by the M_{edit} trainer 212 to train the fine-tuned second set of layers M′_{k+1 . . . L} 124 and the low-rank adaptation module Δ 126. Upon initiating training (at block 500), the operations at blocks 402 and 404 in FIG. 4 are performed to obtain a set of augmented samples of data to unlearn 206 and data to learn 208. The augmented samples are tokenized (at block 504) to generate sets of tokens for the samples and the sets of tokens are inputted to the first set of layers M_{1 . . . k} 114 to produce activations for the tokens in interim outputs for the samples. The interim outputs for the unlearn and keep samples are inputted (at block 506) to the second set of layers M_{k+1 . . . L} 118 to perform contrastive learning to train the second set of layers 118 to discriminate between unlearn and keep data, resulting in a fine-tuned second set of layers M′_{k+1 . . . L} 124. The M_{edit} trainer 212 generates (at block 508) a low-rank adaptation module Δ 126 providing a decomposition of a weight update (ΔW) for the weights of M_{edit} that are trained not to output data to unlearn 206. The low-rank adaptation module 126 may comprise one or more matrices having a lower rank of columns and/or rows than the matrix of the fine-tuned second set of layers M′_{k+1 . . . L} 124.

The interim outputs are inputted to the gate classifier 116 to classify (at block 512) the interim outputs as data to keep or data to unlearn. Interim outputs of data classified as to keep are ignored (at block 514). For interim outputs that are classified as data to unlearn (at block 512), the M_{edit} trainer 212 trains (at block 516) the combined matrices M′_{k+1 . . . L}+Δ, with parameters of M′_{k+1 . . . L} 124 frozen, with input comprising the interim outputs for samples to unlearn, to train the weights of the low-rank adaptation module 126 so output of M_{edit}=M′k+1 . . . L+Δ does not include data to unlearn. The M_{edit} trainer 212 may train the weights of the low-rank adaptation module 126, while freezing the weights of the fine-tuned second set of layers 124, using backpropagation, to not output interim outputs classified, by the gate classifier 116, as data to unlearn.

In the embodiment of FIG. 5, the training operations at blocks 504-506 for the fine tuning of M_{k+1 . . . L} and the training operations of the low-rank adaptation module 126 weights may each be performed sequentially for each sample. In an alternative embodiment, the training operations for the two different sets of training operations using the samples may be performed by batching the samples into one or more batches, where the feature vectors of the samples in the batch comprise concurrent vectors or a matrix of sample feature vectors to perform batch gradient descent to train.

In an alternative embodiment, the second set of layers 124 may not be fine-tuned, and M_{edit} may comprise the original second set of layers 118 combined with the low-rank adaptation module 126, e.g., M_{edit}=M_{k+1 . . . L}+Δ. In such case, the weights of the second set of layers 118 are kept constant, i.e., frozen, while the weights of the low-rank adaptation module 126 are trained to not output the data to unlearn.

With the embodiment of FIG. 5, training is optimized by using the gate classifier 116 to distinguish between unlearn and keep data so that the fine-tuned second set of layers M_{k+1 . . . L} 124 do not all have to be trained and instead the low-rank adaptation module 126 comprising lower rank matrices of fewer parameters/weights of the fine-tuned second set of layers 124 are trained to not output data to unlearn. In this way, the training is optimized to only have to train low-rank matrices of the fine-tuned second set of layers 124 instead of having to train all L layers of the full model M_{1 . . . L}.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

Computing environment 600 contains an example of an environment for the execution of at least some of the computer code involved in performing the inventive methods, including to split a machine learning model of L layers into multiple sets of layers and a gate machine learning model to direct output from the set of layers of the model to the second set of layers or a modified second set of layers so data to unlearn is not outputted.

The computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 601, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

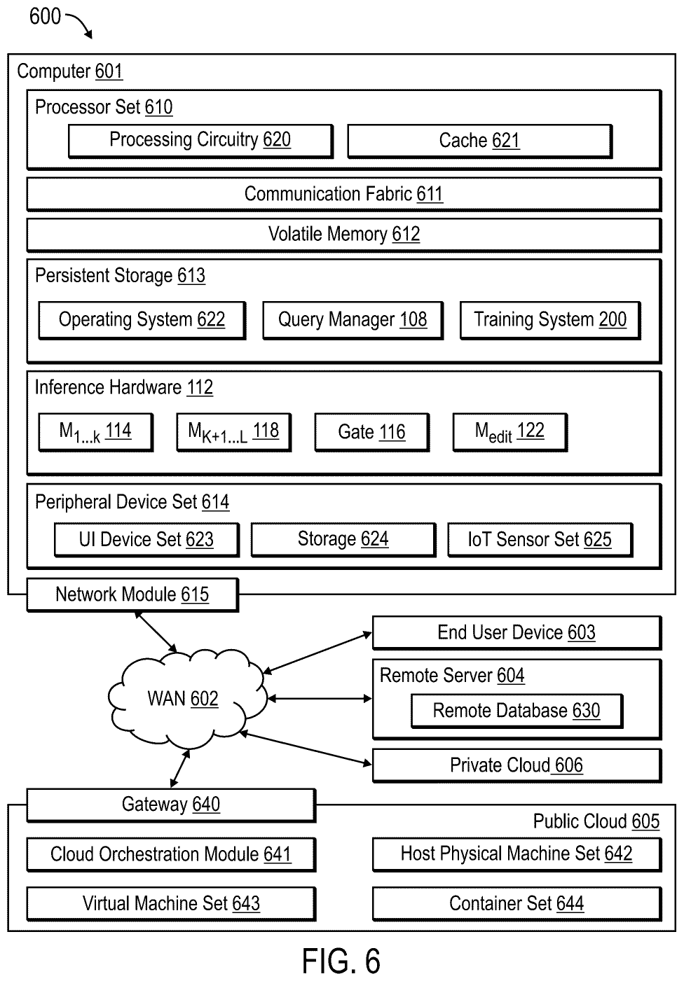

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The persistent storage 613 may include a query manager 108 and program components 204 and 212 of the training system 200 as descried in FIGS. 1 and 2.

INFERENCE HARDWARE 112 may comprise the inference hardware of FIG. 1 including the machine learning models 114, 118, 116, and 122 to provide a modified model that will not output data to unlearn. The inference hardware 112 may comprise an ASIC, GPU, FPGA, etc.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on. In certain embodiments, the EUD 603 may comprise client computers that submit the query for the inference hardware 112 to process to return a response to the query.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for processing unlearning data from a machine learning model having L layers, the computer program product comprising a computer readable storage medium having computer readable program code embodied therein that is executable to perform operations, the operations comprising:
processing a query at a first set of layers of the L layers of the machine learning model to determine interim output;
classifying the interim output as data to unlearn or data to keep for the machine learning model;
processing the interim output at a second set of layers of the L layers of the machine learning model to produce a first output in response to classifying the interim output as data to keep for the machine learning model;
inputting the interim output to an edited machine learning model formed from the second set of layers to output second output in response to classifying the interim output as the data to unlearn from the machine learning model; and
returning one of the first output or the second output as a response to the query.

2. The computer program product of claim 1, wherein a gate classifier classifies the interim output as the data to unlearn or data to keep for the machine learning model, wherein the operations further comprise:
selecting a set of samples comprising unlearn samples comprising the data to unlearn and keep samples comprising samples to keep;
receiving labels comprising an unlearn value for the unlearn samples and a keep value for the keep samples; and
training the gate classifier to output the unlearn value for input comprising features derived from a sample labeled with the unlearn value and output the keep value for input comprising features derived from a sample labeled with the keep value.

3. The computer program product of claim 2, wherein the training the gate classifier comprises:
tokenizing samples labeled with the unlearn value or the keep value;
inputting the tokens for the samples into the first set of layers to obtain activations for the tokens; and
averaging the activations for the tokens to produce features of interim outputs for the samples to input to the gate classifier to train the gate classifier to output the keep value or the unlearn value for the activations.

4. The computer program product of claim 2, wherein the operations further comprise:
selecting the keep samples that are semantically similar to the unlearn samples.

5. The computer program product of claim 1, wherein a gate classifier determines whether the interim output is similar to the data to unlearn from the machine learning model, wherein the operations further comprise:
augmenting samples in a set of samples to produce augmented samples comprising augmented unlearn samples and augmented keep samples, wherein the augmented samples are formed by lexical substitution to augment the samples with synonyms and other semantically similar terms;
labeling the augmented unlearn samples with an unlearn value indicating data to unlearn and labeling the augmented keep samples with a keep value indicating data not to unlearn; and
training the gate classifier to output the unlearn value for the samples labeled with the unlearn value and output the keep value for the samples labeled with the keep value.

6. The computer program product of claim 1, wherein the operations further comprise:
training the edited machine learning model to receive, as input, interim outputs from the first set of layers and not output the data to unlearn.

7. The computer program product of claim 6, wherein the training the edited machine learning model to not output the data to unlearn comprises:
selecting a set of samples comprising unlearn samples comprising the data to unlearn and keep samples comprising samples to keep; and
using contrastive learning to train the second set of layers with input comprising interim outputs from the first set of layers to distinguish between interim outputs from the samples to keep and the samples to unlearn.

8. The computer program product of claim 6, wherein the edited machine learning model comprises the second set of layers and a low-rank adaptation module, wherein the training the edited machine learning model further comprises:
training weights of the low-rank adaptation module, holding weights of the second set of layers constant, to not output interim outputs received as input comprising data to unlearn.

9. The computer program product of claim 8, wherein the training the edited machine learning model further comprises:
classifying, by a gate classifier, the interim outputs as data to keep or data to unlearn, wherein the weights of the low-rank adaptation module are only trained with the interim outputs classified as data to unlearn.

10. A system for processing unlearning data from a machine learning model having L layers, comprising:
inference hardware comprising
a first set of layers of the L layers of the machine learning model to processing a query to determine interim output;
hardware logic to classify the interim output as data to unlearn or data to keep for the machine learning model;
a second set of layers of the L layers of the machine learning model to process the interim output to produce a first output in response to classifying the interim output as data to keep for the machine learning model;
an edited machine learning model formed from the second set of layers to receive as input the interim output to output second output in response to classifying the interim output is classified as the data to unlearn from the machine learning model; and
hardware logic to return one of the first output or the second output as a response to the query.

11. The system of claim 10, wherein the inference hardware includes a gate classifier that classifies the interim output as the data to unlearn or data to keep for the machine learning model, further comprising:
a processor; and
a computer readable storage medium having computer readable program code embodied therein that is executable by the processor to perform operations, the operations comprising:
selecting a set of samples comprising unlearn samples comprising the data to unlearn and keep samples comprising samples to keep;
receiving labels comprising an unlearn value for the unlearn samples and a keep value for the keep samples; and
training the gate classifier to output the unlearn value for input comprising features derived from a sample labeled with the unlearn value and output the keep value for input comprising features derived from a sample labeled with the keep value.

12. The system of claim 11, wherein the operations performed by the processor executing the computer readable program code further comprise:
selecting the keep samples that are semantically similar to the unlearn samples.

13. The system of claim 11, wherein the operations performed by the processor executing the computer readable program code further comprise:
training the edited machine learning model to receive, as input, interim outputs from the first set of layers and not output the data to unlearn.

14. The system of claim 13, wherein the training the edited machine learning model to not output the data to unlearn comprises:
selecting a set of samples comprising unlearn samples comprising the data to unlearn and keep samples comprising samples to keep; and
using contrastive learning to train the second set of layers with input comprising interim outputs from the first set of layers to distinguish between interim outputs from the samples to keep and the samples to unlearn.

15. The system of claim 13, wherein the edited machine learning model comprises the second set of layers and a low-rank adaptation module, wherein the training the edited machine learning model further comprises:
training weights of the low-rank adaptation module, holding weights of the second set of layers constant, to not output interim outputs received as input comprising data to unlearn.

16. A computer implemented method for processing unlearning data from a machine learning model having L layers, comprising:
processing a query at a first set of layers of the L layers of the machine learning model to determine interim output;
classifying the interim output as data to unlearn or data to keep for the machine learning model;
processing the interim output at a second set of layers of the L layers of the machine learning model to produce a first output in response to classifying the interim output as data to keep for the machine learning model;
inputting the interim output to an edited machine learning model formed from the second set of layers to output second output in response to classifying the interim output as the data to unlearn from the machine learning model; and
returning one of the first output or the second output as a response to the query.

17. The computer implemented method of claim 16, wherein a gate classifier classifies the interim output as the data to unlearn or data to keep for the machine learning model, further comprising:
selecting a set of samples comprising unlearn samples comprising the data to unlearn and keep samples comprising samples to keep;
receiving labels comprising an unlearn value for the unlearn samples and a keep value for the keep samples; and
training the gate classifier to output the unlearn value for input comprising features derived from a sample labeled with the unlearn value and output the keep value for input comprising features derived from a sample labeled with the keep value.

18. The computer implemented method of claim 16, further comprising:
training the edited machine learning model to receive, as input, interim outputs from the first set of layers and not output the data to unlearn.

19. The computer implemented method of claim 18, wherein the training the edited machine learning model to not output the data to unlearn comprises:
selecting a set of samples comprising unlearn samples comprising the data to unlearn and keep samples comprising samples to keep; and
using contrastive learning to train the second set of layers with input comprising interim outputs from the first set of layers to distinguish between interim outputs from the samples to keep and the samples to unlearn.

20. The computer implemented method of claim 18, wherein the edited machine learning model comprises the second set of layers and a low-rank adaptation module, wherein the training the edited machine learning model further comprises:
training weights of the low-rank adaptation module, holding weights of the second set of layers constant, to not output interim outputs received as input comprising data to unlearn.
